(19) United States
(12) Patent Application Publication
(10) Pub. No.: US 2008/0052972 A1
(43) Pub. Date: Mar. 6, 2008

(54) Door handle

(76) Inventor: Ulrich Karcher, Bad Wimpfen (DE)

Correspondence Address: Howard IP Law Group, P.O. Box 226, Fort Washington, PA, 19034, US

(21) Appl. No.: 11/728,437

(22) Filed: Mar. 26, 2007

(30) Foreign Application Priority Data
Sep. 6, 2006 (DE) 000584628-0002
Sep. 6, 2006 (EP) 000584628-001
Feb. 8, 2007 (DE) 10 2007 002 019.7
Feb. 8, 2007 (EP) 10 2007 007 015.4

(51) Int. Cl. G09F 3/00

(52) U.S. Cl. 40/331

(57) ABSTRACT

The present invention relates to a door handle having a connection part for mounting the door handle on a door and having a handle body for manual operation of the door handle. The handle body has an information section that carries haptically discernible information.

### FIELD OF THE INVENTION

The present invention relates to a door handle.

### BACKGROUND OF THE INVENTION

A conventional door handle has a connection part for mounting the door handle on a door and a handle body for manual operation of the door handle.

### SUMMARY OF THE INVENTION

The present invention relates to the problem of providing an embodiment that is characterized in particular by an increased utilitarian value resulting from an additional functionality, for example.

The invention is based on the general idea of providing the handle body with haptically discernible information. In this way it is possible to impart information haptically to a person operating the door handle. For example, this may be information pertaining to a door equipped with the door handle and/or information pertaining to a room that may be entered through the door equipped with the door handle. For example, it is conceivable to mount a room number as information on the handle body of the respective door handle, so that it can be perceived by touch, e.g., in the case of officials, office complexes, hospitals or hotels. This is a great advantage for people who are visually impaired, especially the blind, because they have access to the required information, namely whether it is the correct door and/or the correct room, immediately on coming in contact with the door handle. It is essentially conceivable for such information to be mounted in the traditional manner so that it is discernible by touch anywhere on the door or anywhere on the door frame or anywhere on a wall area near the door. However, the respective person must first locate any such information, but this is not always entirely easy because more or less any possibilities are available for arranging such information. In contrast with that, the door handle of any door is always essentially located in the same area and is therefore comparatively easy to find, even for those who are blind or visually impaired. Thus, mounting haptically discernible, i.e., tactile, information directly on the handle body of the door handle makes the situation much easier for people who are visually impaired, thus enabling them to find their way more easily in an environment with which they are not familiar. The door handle has an important additional function which increases the utilitarian value of the door handle accordingly due to its use as an information carrier.

According to an embodiment, the information on the door handle body may be in the form of embossed characters or braille. This information is “readable” by people having a severe visual impairment in a comparatively easily discernible, standardized representation.

The information is arranged on the door handle body within an information section which, according to an embodiment, may have an insertion part that is a separate component with regard to the handle body and carries said information. In this way it is possible in particular to manufacture the door handles in the same way by mass production and to only individualize them thereafter by attaching the insertion parts provided with the information intended for the respective door handle. In particular, the insertion parts thus provided with the relevant information can also be applied to a door handle that has already been installed in order to reduce the risk of confusion in installation of the door handles.

According to another embodiment of the invention, it is possible to provide for the respective information section to also have a recess provided in the handle body into which the respective insert part can be inserted.

This design simplifies the attachment of the respective insert part. At the same time, a dimensionally integrated form is achieved, thus reducing the interfering contours and therefore the risk of injury.

It is self-evident that the features described above and those yet to be explained below may be used not only in the particular combination given but also in other combinations or alone without going beyond the scope of the present invention.

Exemplary embodiments of the invention are depicted in the drawings and explained in greater detail in the following description, where the same reference numerals refer to the same or similar or functionally identical components.

### BRIEF DESCRIPTION OF THE DRAWINGS

The drawings show, each in schematic diagrams:

FIG. 1 is a view of a door handle, as viewed in a direction extending from the door toward the handle,

FIG. 2 is a view of a door handle, as viewed in a direction extending from the handle toward the door.

### DETAILED DESCRIPTION OF THE INVENTION

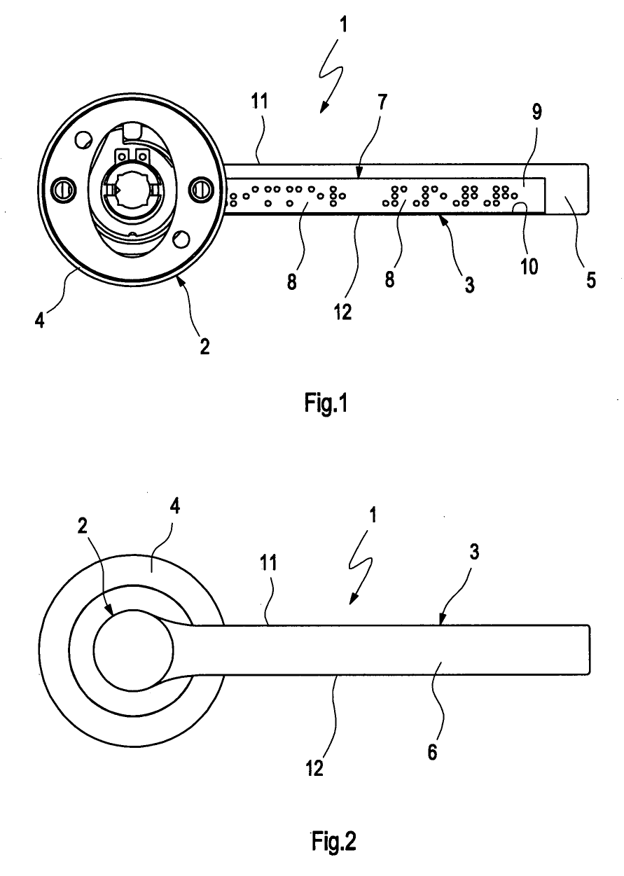

According to FIGS. 1 and 2, a door handle 1 includes a connection part 2 and a handle body 3. With the help of the connection part 2, which includes a collar 4 in particular, the respective door handle 1 may be mounted on a door (not shown). The handle body 3 is used for manual operation of the door handle 1 and is designed as a latch in the example shown here. Essentially, however, it is also possible to design the handle body 3 as a knob.

FIG. 1 shows an inside view of the door handle 1 so that the observer is looking at the inside 5 of the handle body 3 which, in the installed state of the door handle 1, is facing the door on which the door handle 1 is mounted. In contrast with that, FIG. 2 shows an outside view of the door handle 1 in which an outside 6 of the handle body 3 is facing the observer, so that in the installed state, this outside is facing away from the door equipped with the door handle 1.

According to FIG. 1, the handle body 3 is equipped with at least one information section 7. This information section 7 carries haptically discernible information 8. The information section 7 is arranged on the inside 5 of the handle body 3 in the preferred exemplary embodiment shown here. In this way, the door handle 1 has the appearance of an ordinary door handle 1 from the outside according to FIG. 2. The information becomes “readable” only when a person grips the door handle 1 by the handle body 3 and, in doing so, touches the information section 7.

It is likewise fundamentally possible for the information section 7 to also be mounted on the outside 6 or on a top side 11 or on a bottom side 12 of the handle body 3. Likewise, the handle body 3 may also be equipped with multiple information sections 7.

The information 8 is directed in particular at people having a comparatively severe visual impairment and the blind in particular. Accordingly, the information 8 is preferably depicted in embossed characters and/or braille. Therefore, the information is comparatively easily readable by people who are able to read embossed characters as soon as they touch the handle body 3 by hand and sense the information 8 with their fingertips.

In the example presented here, the respective information 8 is depicted in braille characters; this is a relatively widespread method of encoding traditional characters in the form of dot characters. As an alternative, the information 8 may also be depicted by Moon characters. This involves another type of embossed characters formed by a different alphabet, namely the Moon alphabet which uses traditional characters in a simplified or modified form in the form of relief characters.

Essentially it is also possible to use a writing that works with traditional characters instead of very specialized braille, which works with special encoded or modified characters, although they are depicted as a relief. Such traditional relief characters are thus fundamentally readable by the visually impaired as well as those who are not visually impaired.

Information 8, which is depicted on information section 7 of the respective door handle 1, is preferably information 8 pertaining to the door equipped with the door handle 1 and/or pertaining to a room that can be entered through the door equipped with the door handle 1. In a simple case, the information 8 includes only the room number of the room that can be entered through the door equipped with this door handle 1. For example, the information 8 may comprise “room 1528” to be translated into black characters readable by the sighted. In addition, the information may also signify “emergency exit” or “ladies restroom” or “director's office” or “please knock” or the like.

In an exemplary embodiment shown here, the information section 7 includes at least one insert part 9 which forms a separate part with respect to the handle body 3 and carries the information 8. The insert part 9 may thus be manufactured independently of the handle body 3 and may be made of a different material. In the finished state of the door handle 1, the respective insert part 9 is attached to the handle body 3. For example, the insert part 9 can be detachably attached to the handle body 3 by clipping it there. Likewise it may also be glued in place. Furthermore, with the exemplary embodiment shown here, the information section 7 has at least one recess 10, which is incorporated into the handle body 3 and/or designed in it and into which the respective insert part 9 can be inserted. The recess 10 is expediently coordinated with the insert part 9 in such a way that the insert part 9 in the installed state is inserted to be essentially flush so that the insert part 9 is arranged on the handle body 3 so that it is integrated into the shape of it.

To simplify the tactility and/or readability of the information 8, the information section 7 is designed to be planar in the embodiment shown here. The information section 7 and/or the insert part 9 then has a planar base area from which the information 8 and/or the respective characters are emphasized in a positive or negative sense to depict the information 8. Positively emphasized characters to depict the information then form relief type elevations with respect to the base area. In contrast with that, negatively emphasized characters for depicting the respective information 8 form engraving-like recesses in the respective base area. The handle body 3 may be equipped with a planar surface in the area of the information section 7, which improves the integration of the information section 7. Thus the inside 5 is essentially designed to be planar in this example.

1. A door handle comprising:
a connection part for mounting the door handle on a door; and
a handle body for manual operation of the door handle,
wherein said handle body has at least one information section that carries haptically discernible information.

2. The door handle according to claim 1, wherein said haptically discernible information is represented by embossed writing.

3. The door handle according to claim 1, wherein said haptically discernible information is depicted by relief characters or by dot characters.

4. The door handle according to claim 1, wherein said haptically discernible information is depicted by braille or Moon characters.

5. The door handle according to claim 1, wherein said haptically discernible information pertains to the door equipped with said door handle.

6. The door handle according to claim 1, wherein said haptically discernible information pertains to a room that can be entered through the door equipped with said door handle.

7. The door handle according to claim 1, wherein said information section comprises at least one insert part that is a separate component with regard to said handle body, said at least one insert part carrying the information.

8. The door handle according to claim 7, wherein said information section further comprises at least one recess formed in the handle body into which said at least one insert part is inserted.

9. The door handle according to claim 7, wherein said at least one insert part comprises a planar base area from which said information stands out in a positive or negative direction.

10. The door handle according to claim 1, wherein said handle body comprises a planar surface in the area of said information section.

11. The door handle according to claim 1, wherein said information section comprises a planar base area from which the information stands out in a positive or negative direction.

12. The door handle according to claim 1, wherein said information section is arranged on an inside of the handle body, wherein said inside of the handle body faces the door equipped with said door handle in the installed state of said door handle.

13. The door handle according to claim 1, wherein said handle body is a latch.

14. The door handle according to claim 1, wherein said handle body is a knob.
